(19) United States
(12) Patent Application Publication
(10) Pub. No.: US 2005/0164650 A1
(43) Pub. Date: Jul. 28, 2005

(54) Method and system for asymmetric wireless telecommunication with client side control

(76) Inventor: Mathew G. Johnson, Seattle, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/763,780

(22) Filed: Jan. 22, 2004

(51) Int. Cl. G06F 15/16; H04B 1/034

(52) U.S. Cl. 455/95; 709/230

(57) ABSTRACT

A first data set is transmitted to a client device across a plurality of wireless communication networks, each network of the plurality transmitting a corresponding portion of the first data set. A second data set is received from the client device.

### TECHNICAL FIELD

The present invention relates generally to wireless communication networks and more particularly to client-side techniques for optimizing two-way communications over multiple wireless communication networks.

### BACKGROUND OF THE INVENTION

Wireless networking of electronic devices using packetized data transmission protocols such as Internet Protocol (IP), is extraordinarily valuable to people and businesses who use cellular phones, 802.11 Wi-Fi, Bluetooth, and many other protocols to stay connected to friends, family, coworkers, and customers. Unfortunately, the many and varied digital wireless networks that have already been, and continue to be, built are not well integrated.

Further, most populous areas are covered with multiple, overlapping, wireless networks, each built by separate and competing service providers. A consumer who chooses one service provider is able to use only the bandwidth made available by one network infrastructure, leaving the additional overlapping layers underutilized by such consumer.

In addition, each single wireless technology or type of network is severely limited in at least one way. For example, cellular networks, even the newest 3G variety, cover large areas but suffer from lack of bandwidth. They work very well for voice and limited data transmission, but do not handle high volumes of traffic and large file transmission. The popular Wi-Fi standard for wireless LAN (WLAN) connections offers substantially higher rates of data transmission, up to 11 or 54 Mbps depending on standard, but each transmitter can cover only a very limited area. Also, WLAN connections often have a bandwidth bottleneck at the wire where the Wi-Fi router connects to the Internet that limits the bitrate available to the user from a single WLAN connection.

Mesh networking attempts to smooth transitions between different types of networks, but is still limited to utilizing one available network at a time.

Users of wireless networks typically demand bandwidth in an asymmetrical manner, demanding different amounts data flowing upstream and downstream. Typical Internet surfing consumes relatively low bandwidth upstream, as a user requests web pages, and relatively high bandwidth downstream as the web page content is loaded onto the user's device. Users of camera-equipped cellular phones typically use more bandwidth upstream when they upload photos they have taken onto their cellular network to send to friends.

Providers of satellite-based Internet access have invented asymmetric network systems in which downstream traffic is over the satellite channel, and upstream traffic is over a different, often wired channel. This is due to the difficulty and expense of communicating upstream to a satellite. These asymmetric networking methods rely on a proprietary network with a proxy server upstream from both the client and the satellite that enables asymmetric routing of data packet traffic through a means of IP address substitution and relabeling. Unfortunately, this concept is not inclusive of a variety of network connections that may or may not be owned and operated by different entities. Current satellite-focused methods of asymmetrical networking allow asymmetry but are not able to take advantage of the additional bandwidth provided by multiple, overlapping networks.

### SUMMARY OF THE INVENTION

In accordance with an embodiment of the invention, a first data set is transmitted to a client device across a plurality of wireless communication networks, each network communicating directly with the device simultaneously, each network of the plurality transmitting a corresponding portion of the first data set. A second data set is received from the client device.

### DESCRIPTION OF THE DRAWINGS

FIG. 1 is a block diagram that provides an overview of an embodiment of an asymmetric networking scheme according to an embodiment of the present invention;

FIG. 2 is a block diagram that illustrates the downstream control of a network device of FIG. 1 according to an embodiment of the invention;

FIG. 3 is a block diagram of the network manager of FIG. 1 according to an embodiment of the invention;

FIG. 4 is a flowchart describing the establishment and operation of client-side asymmetric network controls according to an embodiment of the invention;

FIG. 5 is a flowchart describing a method according to an embodiment of the invention by which identifier suppression control is managed;

FIG. 6 is a graph illustrating the convergence of downstream packet flow specified by a routing algorithm with the actual observed downstream traffic at a particular network device in a probabilistic scheme for asymmetric networking employing client side control according to an embodiment of the invention;

FIG. 7 is a diagram of a 'dashboard' representation of the controls and arrangement of a method for asymmetric network employing client side control according to an embodiment of the invention; and

FIG. 8 is a diagram illustrating three possible embodiments of the present invention.

### DETAILED DESCRIPTION OF THE PREFERRED EMBODIMENTS

Hereinafter, examples of the embodiments of the present invention will be described while referring to the accompanying drawings.

The system and method of the present invention solves the problems described herein by integrating disparate wireless networks and networking protocols that are available at a particular location, and establishing an asymmetric network routing strategy between available networks through client side control.

A method according to the present invention provides a means to utilize the maximum bandwidth available for networking at a particular location and provides a flexible means to optimize data transfer speed upstream and downstream as well as quality of service and cost to the user at different locations where different amounts of bandwidth, and different numbers and types of network connections are available.

A first aspect of a system and method according to the present invention makes available previously unusable bandwidth at locations where multiple networks overlay one another by connecting simultaneously to several available networks; one very common example being locations served by more than one cellular network. The prior art teaches away from this aspect of the present invention by addressing the concept, and envisioning the nature of multiple extant networks as discrete RF footprint areas, where a client device can switch between networks as the physical boundary of two adjacent wireless networks is crossed and described by the term mesh networking.

A second aspect of a system and method according to the present invention makes available the advantages of an asymmetric networking strategy featuring client-side control that eliminates the need for a cumbersome proprietary network and proxy server arrangement. This aspect of the present invention enables asymmetric networking between different networks that may be owned and operated by different entities. The prior art teaches away from this aspect of the present invention by implying that an asymmetric networking strategy can only be implemented by controls operating upstream from the client.

As described below, a system and method according to the present invention attempts to connect all client side network devices and tests the performance of each device successfully connected. Connection availability and performance test results are applied to an algorithm that determines the optimal asymmetric routing strategy. Request packets generated by the client are directed to a particular client side network device out of several available devices as determined by the performance test algorithm. The bandwidth resources available to each network device are allocated between upstream and downstream traffic. For example, 100% of network resources could be devoted to upstream flow, 50% of bandwidth allocated in each direction, 100% of bandwidth devoted to downstream flow, or an intermediate allocation, depending on the performance tests. Setting this control to allocate 100% of bandwidth in one direction has the effect of blocking all passage of data packets in the opposite direction.

According to an embodiment of the invention, a system and method determines what portion of returning response packets should reach each connected client side network device based on a routing strategy algorithm and assigns a unique identifier address advertisement suppression level to each connected device. A client device has a unique identifier that establishes its position in a network. The suppression level is implemented by a reduction in the frequency with which the single client address is advertised by each connected network device. An unsuppressed device identifies itself as it normally would so that downstream packet traffic can be correctly addressed and received by the client device. When more than one device advertises the same identity in an unsuppressed way, there is an equally likely probability that a particular packet will be received by any of the devices. Complete restriction (i.e., suppression) of the identifier of one device returns a probability that no packets directed to that identifier will be received there, instead, the probability is 100% that a packet directed to the identifier will be received by the other devices. Various intermediate levels of suppression result in effective probabilistic control of downstream packet flow, eliminating the need for dedicated or proprietary upstream server architecture. The actual portion of response packets arriving through each connected network device is monitored. The unique identifier address advertisement suppression level is adjusted accordingly to more closely approach the optimal response packet distribution determined by the performance test algorithm in a feedback-control mechanism. All response packets from each connected network device are aggregated before passing the complete packet stream on to the client's applications. Each such response packet may be received via a wireless network over which request data was transmitted or may be received via different suitable means, such as, for example, by land line or wireless network over which request data was not transmitted.

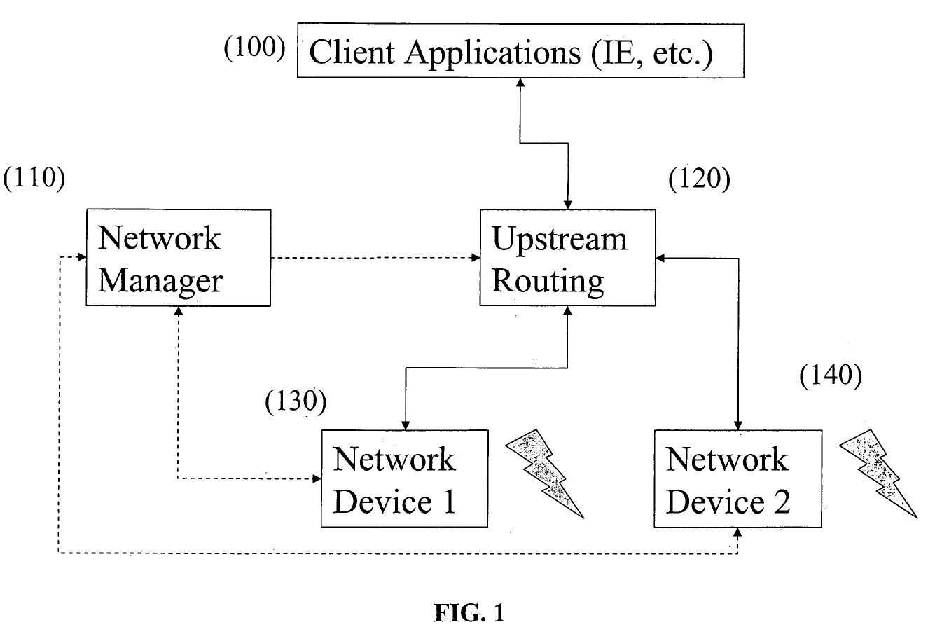

FIG. 1 is a block diagram that provides an overview of a simple embodiment of an asymmetric networking scheme as described by the present invention that incorporates two network interface cards. In this scheme, Network Device 1 handles all upstream/outbound traffic and zero downstream traffic. Network Device 2 handles all downstream traffic and zero upstream traffic. The Network Manager controls the upstream/outgoing traffic at the Upstream Routing component and at each Network Device. Downstream traffic is controlled at each Network Device. Client applications function as normal without special provisions.

In an embodiment, Client application 100, which can be any application capable of communicating over a network such as an email client, Internet browser, or telephone application, generates data to be transmitted over a network connection. Data from 100 is directed to one of several network devices via upstream routing controller 120 which directs data traffic based on a rule defined by network manager 110. The rule is defined by network diagnostic data received from network devices 130 and 140. Outgoing, upstream data from 120 is conveyed to a network through network device 130. Responses and other incoming data are received by network device 140 and then conveyed to 100 via upstream routing controller 120. In an alternative embodiment, a single network device 130 may be employed for simultaneous bi-directional communication over multiple frequency ranges with multiple nodes, such as antenna towers, associated with multiple wireless networks.

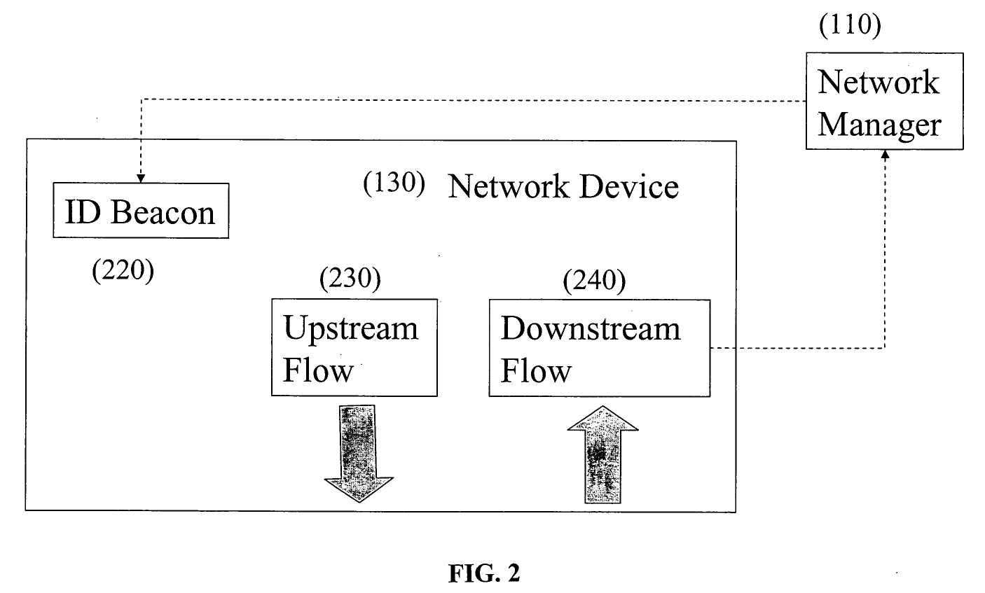

FIG. 2 is a block diagram that illustrates the downstream control of one Network Device in detail. The Network Manager dictates and restricts the natural strength of an identifying signal that identifies the client to other network nodes. An identifying signal of relatively lower strength than other Network Device sharing the same identity will result in a low probability that an incoming packet directed to the client will be directed through the low-signal Network Device. Similarly, complete suppression of the identifier will result in a zero probability that incoming packets will be routed to the suppressed Network Device. Higher signal strength devices that are subject to lower levels of identifier suppression will cause incoming packets to be directed through the high-signal Network Device with a high probability.

Actual incoming/downstream packet traffic is monitored by the Network Manager, which then adjusts the level of identifier suppression using the data over a transmission period. Each adjustment during the transmission period acts to converge the amount of downstream traffic allocated to each Network Device by the Routing Algorithm with the actual downstream traffic observed.

In an embodiment, Network Manager 110 determines the optimal identifier suppression level for Network Device 130. The suppression control is applied to Unique Identifier Beacon 220 by Network Manager 110. Subsequent downstream information flow passing through Network Device 130 is monitored at Downstream Flow receiver 240 and diagnostic information from 240 is conveyed to 110. Network Manager 110 uses the diagnostic information from 240 to adjust the suppression rule applied to Unique Identifier Beacon 220.

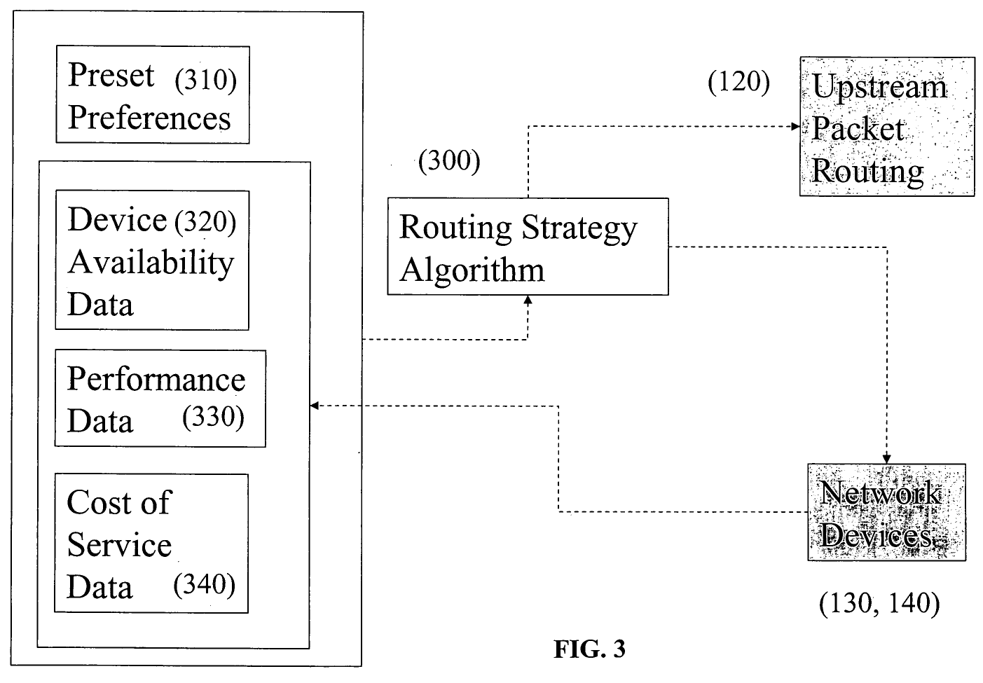

FIG. 3 is a block diagram of the Network Manager. Data is gathered from numerous sources, including preset preferences specified by a vendor, service provider, or user, and a number of data sets gathered from the network feedback of each Network Device including performance diagnostics, cost of service data and device availability for each connection established.

The Routing Strategy Algorithm 300 resolves all of the data inputs and implements a routing strategy that controls the direction and flow of network traffic to and from each Network Device. The controls are implemented at both the Upstream Packet Routing component, and the Network Devices themselves. In an embodiment, the routing strategy can be partially or completely dictated by manual imposition of constraints on bandwidth assignment and/or suppression of the identifying signal through the use of, for example, a graphical user interface associated with the client device. In an alternative embodiment, the Routing Strategy Algorithm may be implemented by one or more components, such as a processor, upstream of the client device.

In an embodiment, the Network Manager compiles data from Preset Preferences 310, Device Availability 320, Network Performance 330, and Cost of Service 340 that describes each available network connection. The compiled data is input to Routing Strategy Algorithm 300. Routing Strategy Algorithm 300 chooses an optimal routing strategy for network traffic based on the data from 310, 320, 330, and 340. The optimal routing strategy is then applied to Upstream Packet Routing 120, and Network Devices 130,140. Upstream packet Routing 120 distributes information generated by client applications and intended for a network to the Network Device specified by 300. The Routing Strategy Algorithm also determines the level of Identifier Suppression control applied to each Network Device 130,140. As Network Devices 130,140 communicate with networks, further packet traffic diagnostic data is returned to 310, 320, 330, and 340. The further diagnostic data is then used to refine the optimal routing strategy.

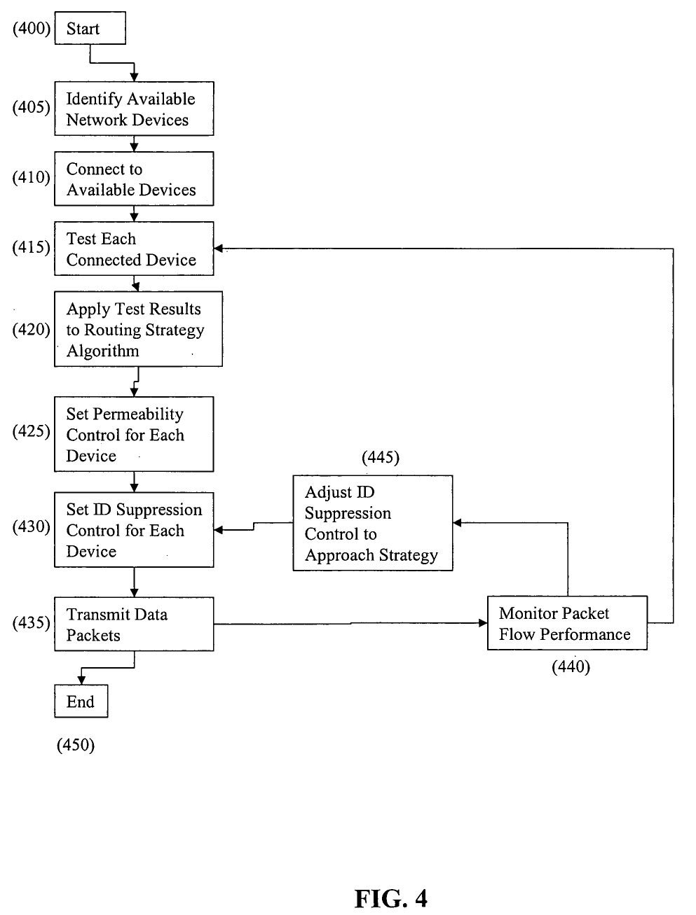

FIG. 4 is a flowchart describing the establishment and operation of client-side asymmetric network controls. The flowchart shows a continuous feedback control mechanism that adjusts the network characteristics of a client device based on diagnostic data describing prior network traffic.

In an embodiment, network connection is initiated in step 400. The Network Manager identifies the multiple network connections available in 405. An attempt is made to connect to each of the available network devices in 410. Performance and Cost of Service diagnostic data for each network connection is compiled and analyzed in 415. Results from step 415 are conveyed to the Routing Strategy Algorithm in 420 where the optimal routing strategy rule is chosen based on the data from 415. The rule from 420 is applied to the upstream routing packet traffic permeability control in 425 where the total amount of available bandwidth for each device is divided and apportioned between upstream and downstream traffic. The rule from 420 is used to set the unique identifier suppression level in step 430 that limits the ability of each network device to establish the location of the client device in a network. Network communication begins in 435 based on the settings implemented in 425 and 430. Network operating performance data is collected continuously in 440. The information collected in 440 is applied in 445 to adjust the identifier suppression control to more closely approach the optimal downstream traffic level determined in 420 and implemented in 430. The data collected in 440 is also conveyed back to 415 to reevaluate the rule set in 420 in order to maintain continuous optimization of network resources. The network session is terminated in 450.

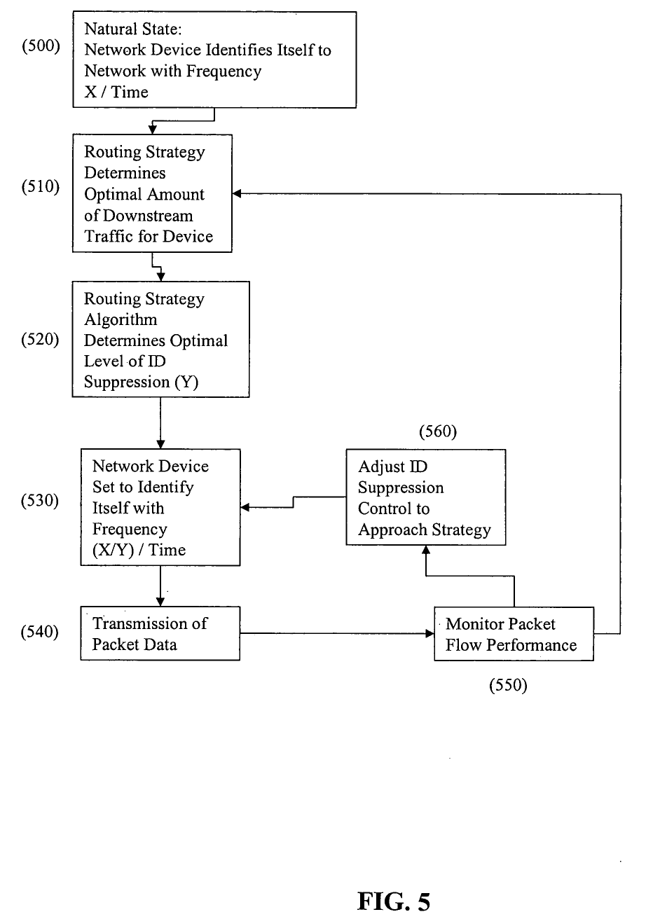

FIG. 5 is a flowchart describing the method by which the identifier suppression control is managed. FIG. 5 shows the same continuous feedback control mechanism as in FIG. 4, but describes in more detail a method that could be used to suppress the unique identifier of a client device in a network environment. Other methods of suppressing a unique identifier within a network are within the scope of the present invention.

In an embodiment, step 500 establishes the natural, unsuppressed level of identification activity implemented in each network device. The routing strategy algorithm determines the proportion of incoming, downstream traffic addressed to the client device that should be received at each network device in 510. In step 520, the optimal traffic level is associated with a degree of device identifier suppression that is then implemented in 530. Network communication is initiated in 540 and performance diagnostic information is collected from 540 in step 550 and used to adjust the suppression level in 530 to approach the optimal traffic proportion determined in 520 as well as to readjust the optimal level based on changes detected in the network environment.

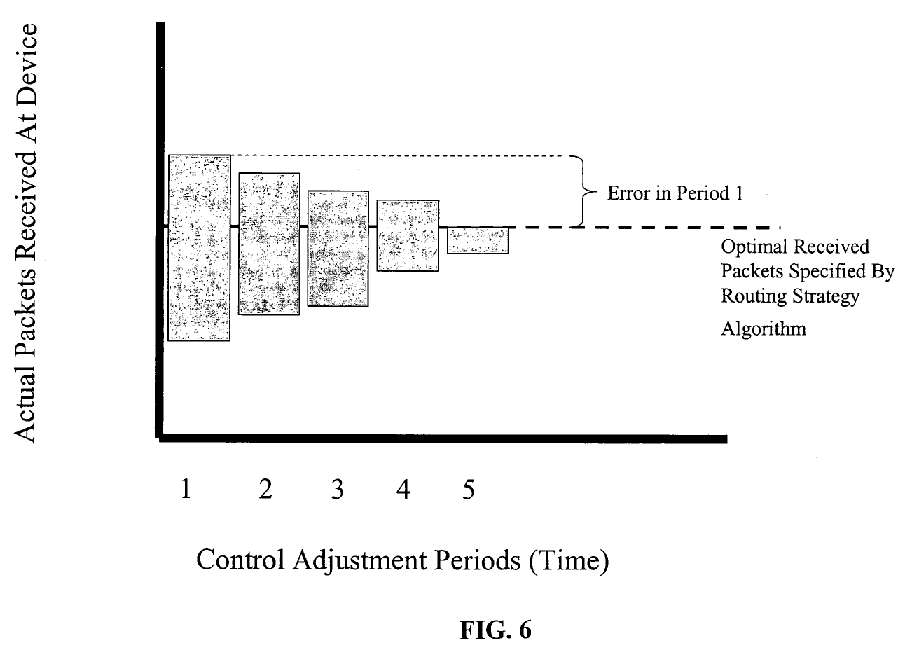

FIG. 6 is a graph illustrating the convergence of downstream packet flow specified by the Routing Strategy Algorithm with the actual observed downstream traffic at a particular Network Device in a probabilistic scheme for asymmetric networking employing client side control. By adjusting the initial network device control settings after each traffic observation period based on the most recent data, downstream network traffic may be regulated from the client side without the need for control extended upstream to other elements within the network. Each successive observation period brings the actual network traffic closer to the optimal level determined by a routing strategy algorithm.

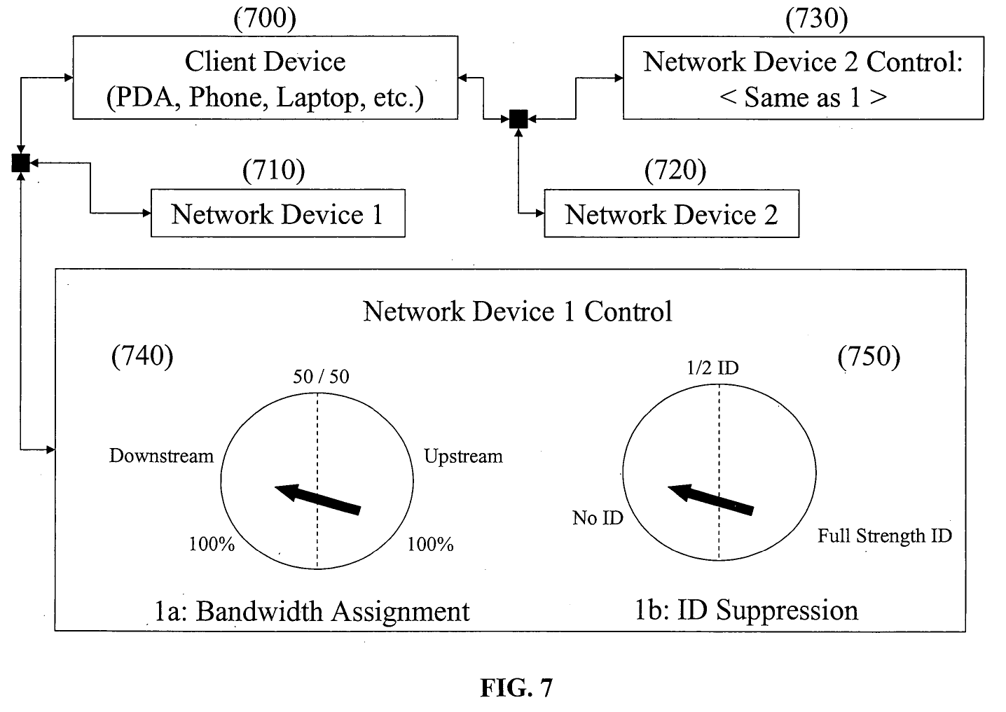

FIG. 7 is a diagram of a 'dashboard' representation of the controls and arrangement of a method for asymmetric network employing client side control. The Permeability Control specifies what proportion of available bandwidth on a particular Network Device is available for use in either direction. The Identifier Suppression Control specifies the level of restriction placed on the normal operation of a Network Device in identifying its location to other network nodes.

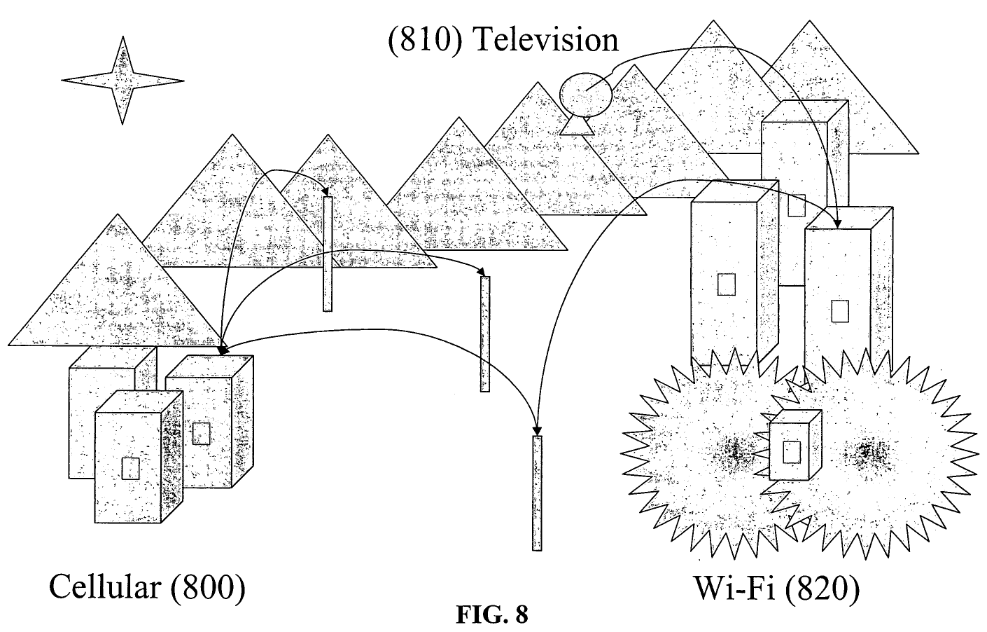

FIG. 8 is a diagram describing three possible embodiments of the present invention. The Cellular embodiment shows three competing service providers who have a joint operating agreement such as the U.S. GSM alliance comprising Cingular Wireless, AT&T Wireless, and T-Mobile USA. A user in an area where all three service providers offer coverage can connect to all three networks simultaneously and utilize three times the communication bandwidth and bit rate available from a single provider.

The Television embodiment shows a user receiving information from a television broadcast transmitter operating under a one-way data transmission protocol and sending information back upstream through a cellular back channel.

The Wi-Fi embodiment shows a user located in an area where more than one Wi-Fi hotspots offer overlapping coverage. In this example, with two overlapping hotspots, the user is able to utilize twice the bandwidth available from a single hotspot.

1. A method, comprising:
transmitting a first data set to a first client device across a plurality of wireless communication networks, each network of the plurality communicating directly with the first client device and transmitting a corresponding portion of the first data set; and
receiving a second data set from the first client device.

2. The method of claim 1, wherein the second data set is transmitted across at least one of the plurality of networks.

3. The method of claim 1, wherein the second data set is transmitted across a medium external to the plurality of networks.

4. The method of claim 1, wherein a first network of the plurality of wireless communication networks is proprietary to a first entity, and a second network of the plurality of wireless communication networks is proprietary to a second entity.

5. The method of claim 1, wherein a second client device transmits the first data set, the second client device selectively assigning each portion of the first data set to a corresponding network of the plurality for transmission thereby.

6. The method of claim 1, wherein a second client device receives the second data set, the second client device selectively assigning a network of the plurality to transmit a corresponding portion of the second data set to the second client device.

7. An apparatus, comprising:
at least one transmitter transmitting a first data set to a client device across a plurality of wireless communication networks, each network of the plurality communicating directly with the client device and transmitting a corresponding portion of the first data set; and
a receiver coupled to the at least one transmitter, the receiver receiving a second data set from the client device.

8. The ensuing claims are for support purposes and will be removed during prosecution. A method for an asymmetrical data communications system using a packetized data transmission protocol that is controlled entirely by mechanisms on the client side, using existing server architecture, the data communications method comprising the steps of:
directing a client request to a particular one of several client side network devices to transmit the request based on a pre-set routing strategy preference and performance data and network usage cost data regarding the disparate network connections available, wherein at least a portion of the performance data is gathered by a given client agent associated with the client, the given client agent gathering a portion of the performance data by processing responses to one or more previous client requests generated by the corresponding client;
managing response packets passively in a probabilistic fashion wherein each client side network device is likely to receive a portion of the total response packets in direct proportion to the level of unique identifier suppression applied to said particular client side network device, the level of suppression being controlled inversely by the frequency of unique identifier advertisement by said particular client side network device, said advertisement enabling a server to locate a particular uniquely identified client device; and
aggregating all response packets received by all of the several client side network devices.

9. The method of claim 8, wherein the client side control of asymmetrical networking using more than one client side network device operating is accomplished with an adjustable packet filtering device that is adjustable in two separate ways fitted to each client side network device such that the controls on each client side network device are adjustable independently.

10. The method of claim 9, wherein the first filtering control mandates the percentage of total bandwidth available that is allocated to upstream and downstream flow, up to 100% in either data packet transmission direction, this aspect of each particular client side network device is controlled independently.

11. The method of claim 9, wherein the second filtering control mandates the suppression of the unique identifier by each client side network device independently of other network devices.

12. The method of claim 11, wherein the unique identifier suppression is achieved by reducing the frequency with which the unique identifier is advertised by each client side network device, the advertisement enabling servers to direct response packets to the correct unique identifier.

13. The method of claim 9, wherein the adjustable controls are regulated in part by algorithms resident on the client device.

14. The method of claim 9, wherein the adjustable controls are regulated in part upstream from the client by a server.

15. The method of claim 9, wherein the adjustable controls are regulated on the client device in part manually by a graphical user interface controlled by the user.
